(19) United States
(12) Patent Application Publication
(10) Pub. No.: US 2026/0049549 A1
(43) Pub. Date: Feb. 19, 2026

(54) BENCHMARKING AND EVALUATION OF LLMS FOR GEOSCIENCE DOMAIN

(71) Applicant: Schlumberger Technology Corporation, Sugar Land, TX (US)

(72) Inventors: Prateek Raj Srivastava, Menlo Park, CA (US); Monisha Manoharan, Menlo Park, CA (US); Advaya Gupta, Menlo Park, CA (US); Sai Shravani Sistla, Menlo Park, CA (US); Jerome Massot, Fairfield, CA (US); Daria Sergeyevna Khvostichenko, Houston, TX (US); Nasser Ghorbani, Houston, TX (US)

(21) Appl. No.: 19/299,560

(22) Filed: Aug. 14, 2025

Related U.S. Application Data
(60) Provisional application No. 63/683,046, filed on Aug. 14, 2024.
(60) Provisional application No. 63/694,149, filed on Sep. 12, 2024.

(51) Int. Cl. E21B 47/12; G06F 16/3329

(52) U.S. Cl. CPC E21B 47/12; G06F 16/3329

(57) ABSTRACT

A method for creating a domain-specific benchmarking dataset for a domain-specific task in an oil and/or gas domain includes receiving input data. The method also includes receiving the domain-specific task that is related to the oil and/or gas domain. The method also includes receiving a prompt from a user. The prompt is received by a text or multimodal large language model (LLM). The method also includes generating a plurality of synthetic instruction-response pairs in response to the prompt based upon the input data and the domain-specific task. The synthetic instruction-response pairs are created by the text or multimodal LLM. The synthetic instruction-response pairs form at least part of the domain-specific benchmarking dataset.

### CROSS-REFERENCE TO RELATED APPLICATIONS

This application claims priority to and the benefit of U.S. Provisional Patent Application No. 63/683,046, filed on Aug. 14, 2024, and U.S. Provisional Patent Application No. 63/694,149, filed on Sep. 12, 2024, both of which are incorporated by reference in their entirety.

### BACKGROUND

The recent advancements in generative AI and large language models (LLMs) have sparked a wave of interest in their potential applications across various scientific fields. Within the energy industry, LLMs trained on vast domain-specific text corpora have found applications in natural language understanding and generation tasks such as question answering, document summarization, and information extraction, etc. In addition, LLMs and multimodal models have also shown promise in revolutionizing various stages of oil and gas exploration and production. In exploration, they can analyze geological data, interpret seismic images, and predict the presence of potential reservoirs. During drilling, they can assist in well planning, optimizing drilling parameters, and interpreting mud logs for geological insights. In production, they can enhance well-completion planning, optimize reservoir management strategies, and facilitate enhanced oil recovery techniques. Given the wide range of potential applications, creating a comprehensive, high-quality, domain-specific benchmarking dataset with relevant tasks has become desired for accurately evaluating their performance and driving further advancements in energy AI.

### SUMMARY

A method for creating a domain-specific benchmarking dataset for a domain-specific task in an oil and/or gas domain is disclosed. The method includes receiving input data. The method also includes receiving the domain-specific task that is related to the oil and/or gas domain. The method also includes receiving a prompt from a user. The prompt is received by a text or multimodal large language model (LLM). The method also includes generating a plurality of synthetic instruction-response pairs in response to the prompt based upon the input data and the domain-specific task. The synthetic instruction-response pairs are created by the text or multimodal LLM. The synthetic instruction-response pairs form at least part of the domain-specific benchmarking dataset.

In another embodiment, the method includes receiving input data. The input data includes annotations. The annotations are related to features in the input data, types of the features, numbers of the features, locations of the features, relative positions between the features, values of the features, and inferences determined based upon the features and the values. The features include geological structures or subsurface properties. The geological structures include faults, unconformities, dips, or folds. The subsurface properties include lithology, porosity, fluid type, or reservoir zones. The values include seismic attributes or well log measurements. The seismic attributes include amplitude, noise, frequency, dip, azimuth, or coherence. The well log measurements include gamma ray, resistivity, density, neutron porosity, sonic travel time, or water saturation. The inferences include structural interpretation, stratigraphic interpretation, lithology identification, or reservoir characterization. The input data with the annotations serves as a ground truth. The annotations are received from a user that is a subject matter expert (SME). The input data is sourced from real-world or simulated environments. The input data is sourced from structured and/or unstructured data including oil and/or gas textbooks, portable document format (PDF) documents, webpages, geophysical surveys, well logs, scientific publications, geological reports, or maps. The input data is in text format, tabular format, graphical format, mathematical format, and/or image format. The input data in the image format is a seismic image. The method also includes receiving the domain-specific task. The domain-specific task includes question answering, report generation, summarization, image captioning and analysis, or measurement log analysis. The domain-specific task is related to the oil and/or gas domain. The oil and/or gas domain includes petroleum engineering, seismic interpretation, well log interpretation, drilling, production, or reservoir simulation. The domain-specific task includes a plurality of examples. The method also includes receiving a prompt from the SME. The prompt is received by a text or multimodal large language model (LLM). The method also includes generating a plurality of synthetic instruction-response pairs in response to the prompt based upon the input data and the domain-specific task. The synthetic instruction-response pairs include question-answer pairs, image-caption pairs, image-annotation pairs, input-summary pairs, multi-turn conversation-response pairs, or input-analysis pairs. The synthetic instruction-response pairs are created by the text or multimodal LLM. The synthetic instruction-response pairs form at least part of the domain-specific benchmarking dataset. The method also includes iteratively assessing and improving an accuracy and a quality of the domain-specific benchmarking dataset based upon feedback from domain-specific models or the SME. The method also includes assessing a performance of different text or multimodal LLMs and/or retrieval augmented generation (RAG) pipelines performing the domain-specific task by comparing responses from the different text or multimodal LLMs and/or RAG pipelines to the domain-specific benchmarking dataset. The method also includes displaying the domain-specific benchmarking dataset. The method also includes performing an action in response to the domain-specific benchmarking dataset.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a high-level workflow for generating benchmark datasets for energy development models, according to an embodiment.

FIG. 2 illustrates a cross-sectional view of a resource site for which the process of FIG. 4 may be executed, according to an embodiment.

FIG. 3 illustrates a networked system illustrating a communicative coupling of devices or systems associated with the resource site of FIG. 2, according to an embodiment.

FIG. 4 illustrates a first exemplary flowchart for generating a question and answer (QA) dataset, according to an embodiment.

FIG. 5A illustrates an implementation where the layered data is directly applied to a transformer engine, according to an embodiment.

FIG. 5B illustrates an implementation where the layered data is not only fed to a first transformer engine, but the output of the first transformer engine is used to generate technical questions with attendant answers which are subsequently fed to a second transformer engine, according to an embodiment.

FIG. 6 illustrates an exemplary dataflow diagram for generating insight data, according to an embodiment.

FIG. 7 illustrates an exemplary workflow for generating benchmark datasets for energy development models, according to an embodiment.

FIG. 8 illustrates an example of a system that includes various management components to manage various aspects of a geologic environment, according to an embodiment.

FIG. 9 illustrates a flow diagram for a benchmark dataset creation process, according to an embodiment.

FIG. 10 illustrates a flowchart of a method for creating a benchmark dataset, according to an embodiment.

FIG. 11 illustrates an example of the input data (e.g., a seismic image), according to an embodiment.

FIG. 12 illustrates an example of annotations in the seismic image, according to an embodiment.

FIG. 13 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if”' may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### A Foundation Model Benchmarking Framework for the Energy Domain

In machine learning, benchmarking computing operations can rely on comparing different models (e.g., AI models) on a given dataset for a desired output such that the benchmarking computing operations can yield a benchmarked solution for a given problem. While large language model (LLM) capabilities have grown significantly and show promise, there has been little work done in quantifying or qualifying their performance and reliability in the energy domain.

Furthermore, benchmark datasets developed for evaluating various LLMs on multiple tasks can be configured to evaluate specific or non-specific (e.g., general-purpose) model capabilities. For example, AI models associated with the Stanford Question Answering Dataset (SQuAD) can be configured for question answering. AI models associated with the Giga Word application can be similarly configured for text summarization. Benchmark datasets like these have little to no representation in the energy domain and are insufficient for evaluating LLMs for energy applications. It is therefore hard to select best performing models when LLMs are used in energy domain contexts.

Moreover, because of the lack and/or usage of benchmark data associated with energy domain context, it is very difficult to confidently deploy LLM models into production for energy applications since the evaluation metrics associated with said LLMs relative to current sets of benchmark datasets are insufficient.

In addition, foundation models have become a big part of the artificial intelligence (AI) discourse, particularly for their applications to multiple tasks such as language translation, question-answering, and content generation among many others. Large Language Models (LLMs) have been given special attention, given their interactivity for humans through natural language. In some instances, LLMs are applied in searchable knowledge bases, smart tickets, information technology (IT) services etc. As these models become powerful, their applications in various industries can become increasingly promising but the study of their functionality, and performance evaluation remain an ever-evolving topic of debate.

Moreover, as an AI model becomes larger and more intricate, the gap between the AI model understanding complex and diverse inputs relative to accurate model outputs can be further widened, making usage of such a model riskier if not employed with caution.

Currently, most of the research on LLMs are lacking detail. There is academic research and open-source benchmarks for LLMs, but these are rather generic and do not capture or characterize the reliability of LLMs in energy domain applications including a searchable energy knowledge base. Information on how these evaluation metrics and benchmarks can be extended to energy domain is often unavailable. There is also currently a lack of streamlined benchmarking frameworks which makes LLM-driven development computing operations fragmented and unreliable.

According to an embodiment, a method for generating benchmark datasets for energy development models. The method can include: structuring energy data to be applied to a first energy development model and thereby generate a first dataset, the first dataset comprising structured energy data indicating at least technical information or technical computations associated with developing an energy resource at a resource site; determining the first energy development model, the first energy development model comprising a large language model; applying, based on the structuring of the energy data, the first dataset to the first energy development model and thereby generate a first set of model predictions by the first energy development model; determining, using a second energy development model that is different from the first energy development model, quantitative performance data for the first energy development model, the quantitative performance data including a first set of quantitative metrics that indicate congruency between the first dataset and the first set of model predictions; generating, based on the first set of model predictions, qualitative performance data for the first energy development model; combining the quantitative performance data with the qualitative performance data and thereby generate insight data, the insight data indicating one or more of: a report indicating textual or image data that provide performance information of the first energy development model, and a model optimization strategy that drives updating the first dataset to generate a second dataset that improves the performance of the first energy development model; and deploying the second dataset for use by the first energy development model or a third energy development model and thereby generate energy development data including at least one of: upstream domain data associated with exploring and producing energy, midstream domain data associated with transporting and storing energy, or downstream domain data associated with refining energy.

In other embodiments, a system and a computer program can include or execute the method described above. These and other implementations may each optionally include one or more of the following features.

Structuring the energy data can comprise formatting the energy data to constitute one or more of: one or more question-answer pairs associated with the energy data; and contextual data elements. In one embodiment, the contextual data elements are associated with the energy data and link one or more question-answer pairs to one or more of: an input applied to the first energy development model or the third energy development model; and/or reference data that inform responses or point to the one or more question-answer pairs based on context data comprised in, or associated with the input applied to the first energy development model or the third energy development model.

It is appreciated that the input applied to the first energy development model or the second energy development model comprises a natural language input.

It is further appreciated that the natural language input comprises syntactic or semantic data parameters that characterize the natural language input. In one embodiment, the semantic or syntactic data may include a logical flow or an arrangement of one or more words comprised in the input.

Moreover, the quantitative performance data comprises one or more of: bilingual valuation understudy (BLEU) data; and recall-oriented understudy for gisting evaluation (ROUGE) data.

In some cases, the second energy development model comprises an examiner language model configured to determine a percentage of answers comprised in the first set of predictions that is accurate in response to applying the first dataset to the first energy development model.

In some embodiments, the qualitative data indicates at least one of: a degree of accuracy with which the first energy development model formats data elements comprised in the first set of predictions; and an ability of the first energy development model to correctly determine accurate context data associated with an input applied to the first energy development model.

In some instances, the first dataset or the second dataset comprises data layers that indicate the energy data such that each data layer includes at least one sub-layer.

According to some embodiments, the data layers limit a context length of the first energy development model or a context length of the third energy development model.

Moreover, the context length may be less than or equal to 4000 tokens per layer size of each data layer comprised in the data layers.

In some cases, generating the qualitative performance data for the first energy development model comprises assessing, based on a ground truth dataset, a first set of model predictions or a second set of model predictions by the first energy development model.

In exemplary implementations, the second energy development model is tuneable or configurable based on one or more of: a use-case associated with first energy domain; a user-specific configuration; a resource-site specific computational or noncomputational setup; or a combination of data relationships between the first energy domain and a second energy domain.

### Overview

The disclosed solution provides a framework for developing benchmarked datasets associated with models (e.g., AI models) for the energy domain by taking hazardous and challenging aspects of the energy industry into account and thereby develop or incorporate expertise data into decision making instead of relying on the LLM models' output. Another benefit provided by the disclosed technology involves providing evaluation metrics associated with a model that compares various models using benchmarked datasets. In particular, the disclosed methods and systems provide a comprehensive framework for benchmarking LLMs for language tasks in the energy domain in a manner that is replicable and holistic.

According to some embodiments, the disclosed solution provides methods, systems, and a framework for benchmarking LLM based applications that provide the following advantages:
1) Curating a domain-specific and a task-specific dataset using computing instructions associated LLMs.
2) Standardizing or regularizing one or more datasets to generate a benchmarked dataset.
3) Analyzing configured and/or new model evaluation techniques or computing operations for using the benchmarked dataset for other models.
4) Publishing a set of computing guidelines, workflows, or logic for establishing such a benchmark, to enable future extensions in the energy industry.
   These aspects are further discussed below under the embodiments section of this disclosure.

### High-level Workflow

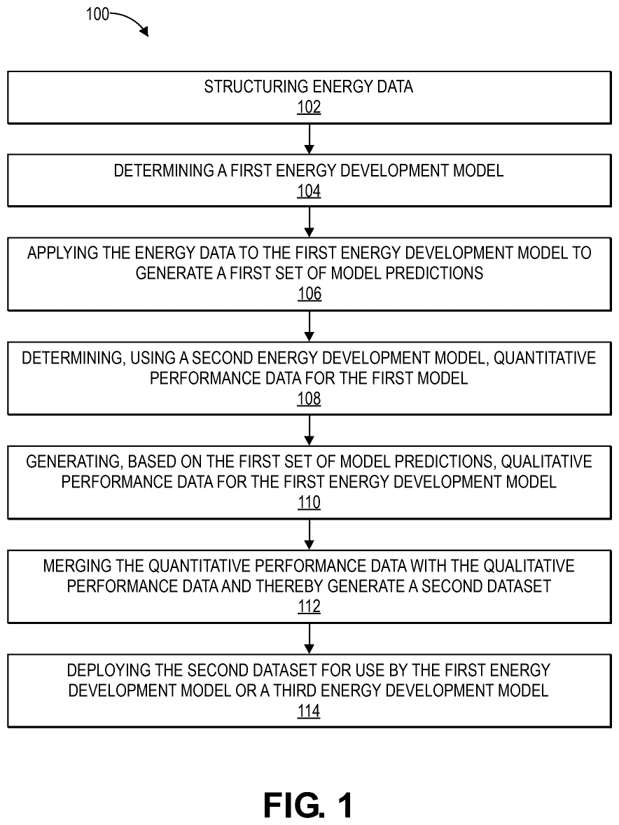

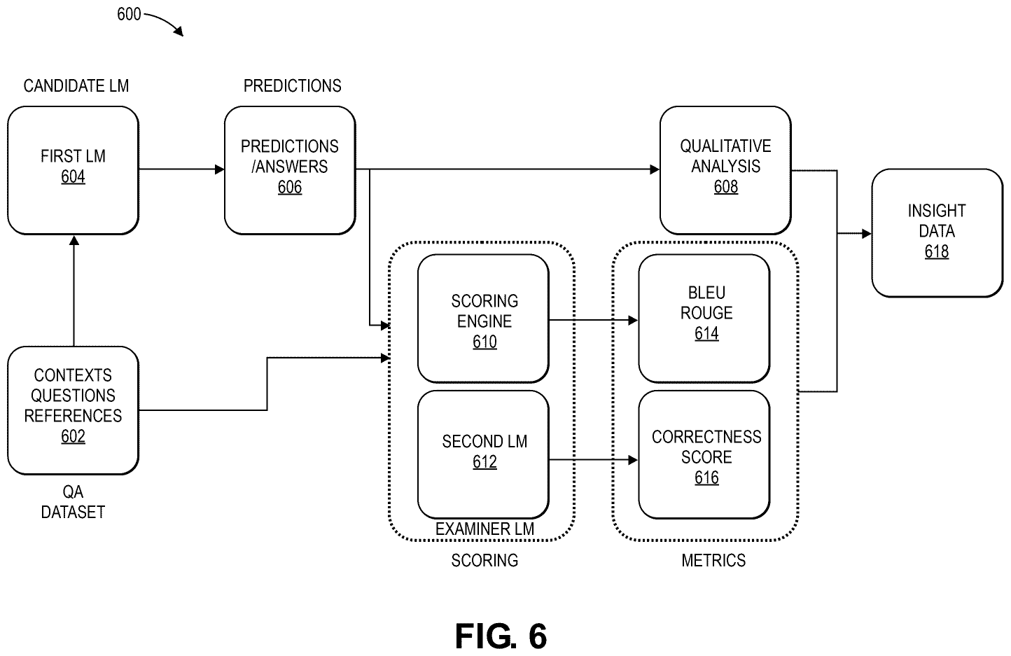

FIG. 1 provides a high-level workflow 100 for generating benchmark datasets for energy development models. In particular, workflow 100 contextually provides a broad description of the various aspects of the detailed workflow of FIG. 7.

At block 102, energy data may be structured for application to a first energy development model. In some embodiments, the first energy development model may be determined, at block 104, so that the energy data may be applied to the first energy development model as indicated at block 106. For example, the energy data may comprise data from or associated with a resource site while the first energy development model may comprise a computing model that represents one or more properties and/or one or more parameters that characterize various aspects of a resource site. In some embodiment, the energy data may comprise a computing logic or a data setup or a strategy for optimally identifying, extracting, and/or processing a resource from a resource site.

At block 108, a second energy development model may be used to generate quantitative performance data in response to applying the energy data to the first energy development model. The second energy development model, according to some embodiments, comprises a computing model adapted for testing and/or reviewing and/or analyzing results generated by the first energy development model.

Furthermore, qualitative performance data may also be generated, at block 110, based on a first set of model predictions obtained from applying the energy data to the first energy development model. In one embodiment, the qualitative performance data may indicate non-quantitative aspects or model properties or parameters of the first energy development model that facilitate accurately generating data predictions by the first energy development model.

At block 112, the quantitative performance data may be merged or combined with the quantitative performance data to generate insight data. This data combination or data merger may include formatting the quantitative performance data and the qualitative performance data into combinable text and/or images and/or symbols and/or graphs and/or charts for display on a graphical interface. In some cases, this data merger or data combination results in a report which is displayable on a graphical display or printable to one or more file formats or printable on a sheet of paper.

At block 114, the second dataset may be deployed for use by the first energy development model or a third energy development model and thereby generate energy development data including at least one of: upstream domain data associated with exploring and producing energy; midstream domain data associated with transporting and storing energy; or downstream domain data associated with refining energy.

### Resource Site

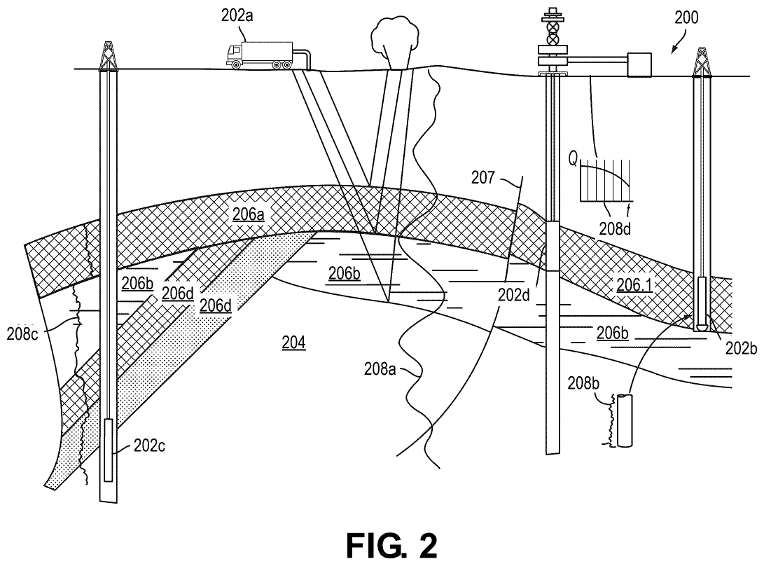

FIG. 2 shows a cross-sectional view of a resource site 200 for which the process of FIG. 1 may be executed. While the illustrated resource site 200 represents a subterranean formation, the resource site, according to some embodiments, may be below water bodies such as oceans, seas, lakes, ponds, wetlands, rivers, or other marine environments.

According to one embodiment, various measurement tools capable of sensing one or more resource site data such as seismic two-way travel time, density, resistivity, production rate, etc., of a subterranean formation and/or geological formations may be provided at the resource site. As an example, wireline tools may be used to obtain measurement information related to geological attributes (e.g., geological attributes of a wellbore and/or reservoir) including geophysical and/or chemical information. For example, the chemical information may include chemical information associated with the subsurface and/or chemical information associated with the surface/above ground areas of the resource site 200.

In some embodiments, various sensors may be located at various locations around the resource site 200 to monitor and collect data and/or core samples for executing the process of FIG. 7.

Part, or all, of the resource site 200 may be on land, on water, or below water. In addition, while a resource site 200 is depicted, the technology described herein may be used with any combination of one or more resource sites (e.g., multiple oil fields or multiple wellsites, one or more saline aquifers, one or more depleted oil/gas fields, etc.), one or more processing facilities, etc. As can be seen in FIG. 2, the resource site 200 may have data acquisition tools 202a, 202b, 202c, and 202d positioned at various locations within the resource site 200. The subterranean structure 204 may have a plurality of geological formations 206a-206d. As shown, this structure may have several formations or layers, including a shale layer 206a, a carbonate layer 206b, a shale layer 206c, and a sand layer 206d. A fault 207 may extend through the shale layer 206a and the carbonate layer 206b. The data acquisition tools, for example, may be adapted to take measurements and detect geophysical and/or chemical characteristics of the various formations shown.

While a specific subterranean formation with specific geological structures is depicted, it is appreciated that the resource site 200 may contain a variety of geological structures and/or formations, sometimes having extreme complexity. In some locations of a given geological structure, for example below a water line (e.g., aquifer) relative to the given geological structure, fluid may occupy pore spaces of the formations. Each of the measurement devices may be used to measure properties of the formations and/or other geological features. While each data acquisition tool is shown as being in specific locations in FIG. 2, it is appreciated that one or more types of measurement may be taken at one or more locations across one or more sources of the resource site 200 or other locations for comparison and/or analysis.

The data collected from various sources at the resource site 200 may be processed and/or evaluated and/or used as training data, and or used to generate high resolution result sets for characterizing a resource at the resource site, and/or used for generating resource models, etc. In one embodiment, the core sample data and/or data collected by a set of sensors at the resource site may include data associated with the number of wells of a first reservoir or second reservoir at the resource site, data associated with the number of grid cells of the first or second reservoir, data associated with the average permeability of the first or second reservoir, data associated with the production duration history (e.g., number of years of production) of the first reservoir or second, etc.

Data acquisition tool 202a is illustrated as a measurement truck, which may comprise devices or sensors that take measurements of the subsurface through sound vibrations such as, but not limited to, seismic measurements. Drilling tool 202b may include a downhole sensor adapted to perform logging while drilling (LWD) data collection. The wireline tool 202c may include a downhole sensor deployed in a wellbore or borehole. Production tool 202d may be deployed from a production unit or Christmas tree into a completed wellbore. Examples of resource site data that may be measured include weight on bit, torque on bit, subterranean pressures (e.g., underground fluid pressure), temperatures, flow rates, compositions, rotary speed, particle count, voltages, currents, and/or other parameters of operations as further discussed below.

Sensors may be positioned about the resource site to collect data relating to various resource site operations, such as sensors deployed by the data acquisition tools 202. The sensor may include any type of sensor such as a metrology sensor (e.g., temperature, humidity), an automation enabling sensor, an operational sensor (e.g., pressure sensor, H₂S sensor, thermometer, depth, tension), evaluation sensors, which can be used for acquiring data regarding the formation, wellbore, formation fluid/gas, wellbore fluid, gas/oil/water comprised in the formation/wellbore fluid, or any other suitable sensor. For example, the sensors may include accelerometers, flow rate sensors, pressure transducers, electromagnetic sensors, acoustic sensors, temperature sensors, chemical agent detection sensors, nuclear sensors, and/or any additional suitable sensors.

In one embodiment, the data captured by the one or sensors may be used to characterize or otherwise generate one or more parameter values for a high-resolution result set used to, for example, label or configure a machine learning (ML) engine, a resource model as the case may require. In other embodiments, test data or synthetic data may also be used in developing the ML engine or resource model (e.g., a subterranean model) via one or more parameterization/labeling operations such as those discussed in association with FIG. 7.

Evaluation sensors may be featured in downhole tools such as tools 202b-202d and may include for instance electromagnetic, acoustic, nuclear, and optic sensors. Examples of tools including evaluation sensors that can be used in the framework of the current method include electromagnetic tools including imaging sensors such as FMI™ or QuantaGeo™ (mark of SLB, Houston, TX); induction sensors such as Rt Scanner™ (mark of SLB, Houston, TX), multifrequency dielectric dispersion sensor such as Dielectric Scanner™ (mark of SLB, Houston, TX); acoustic tools including sonic sensors, such as Sonic Scanner™ (mark of SLB, Houston, TX) or ultrasonic sensors, such as pulse-echo sensor as in UBI™ or PowerEcho™ (marks of SLB, Houston, TX) or flexural sensors PowerFlex™ (mark of SLB, Houston, TX); nuclear sensors such as Litho Scanner™ (mark of SLB, Houston, TX) or nuclear magnetic resonance sensors; fluid sampling tools including fluid analysis sensors such as InSitu Fluid Analyzer™ (mark of SLB, Houston, TX); distributed sensors including fiber optic. Such evaluation sensors may be used in particular for evaluating the formation in which the well is formed (i.e., determining petrophysical or geological properties of the formation), for verifying the integrity of the well (such as casing or cement properties) and/or analyzing the produced fluid (flow, type of fluid, etc.).

As shown, data acquisition tools 202a-202d may generate data plots or measurements 208a-208d, respectively. These data plots are depicted within the resource site 200 to demonstrate that data generated by some of the operations executed at the resource site 200.

Data plots 208a-208c are examples of static data plots that may be generated by data acquisition tools 202a-202c, respectively. However, it is herein contemplated that data plots 208a-208c may also be data plots that may be generated and updated in real time. These measurements may be analyzed to better define properties of the formation(s) and/or determine the accuracy of the measurements and/or check for and compensate for measurement errors. The plots of each of the respective measurements may be aligned and/or scaled for comparison and verification purposes. In some embodiments, base data associated with the plots may be incorporated into site planning, modeling a test at the resource site 200. The respective measurements that can be taken may be any of the above.

Other data may also be collected, such as historical data of the resource site 200 and/or sites similar to the resource site 200, user inputs, information (e.g., economic information) associated with the resource site 200 and/or sites similar to the resource site 200, and/or other measurement data and other parameters of interest. Similar measurements may also be used to measure changes in formation aspects over time.

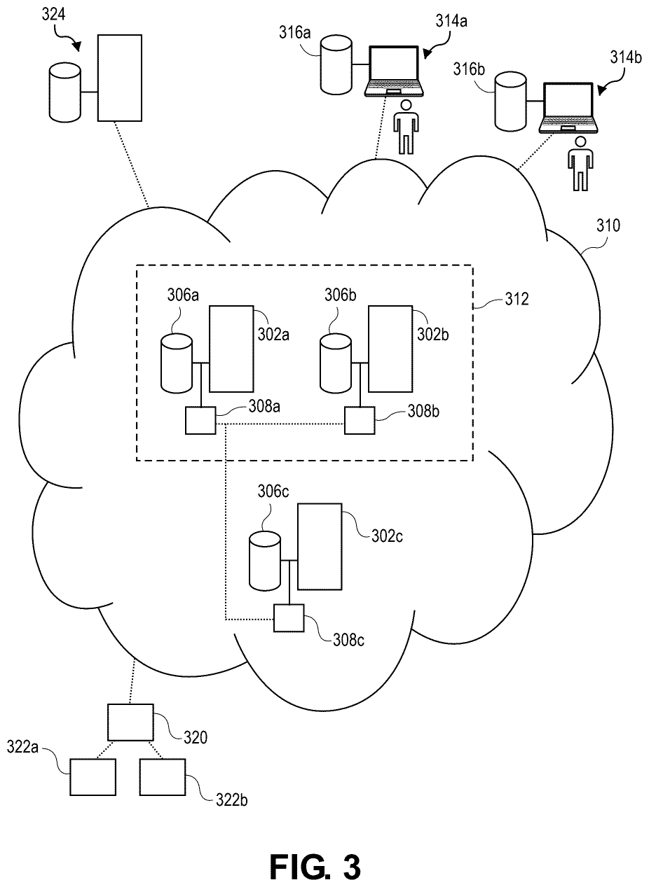

Computer facilities such as those discussed in association with FIG. 3 may be positioned at various locations about the resource site 200 (e.g., a surface unit) and/or at remote locations. A surface unit (e.g., one or more terminals 320) may be used to communicate with the onsite tools and/or offsite operations, as well as with other surface or downhole sensors. The surface unit may be capable of sending commands to the oil field equipment/systems, and receiving data therefrom. The surface unit may also collect data generated during production operations and can produce output data, which may be stored or transmitted for further processing.

The data collected by sensors may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis or for modeling purposes to optimize production processes at the resource site 200. In one embodiment, the data is stored in separate databases, or combined into a single database.

### Network System

FIG. 3 shows a high-level networked system diagram illustrating a communicative coupling of devices or systems associated with the resource site 200 as described in FIG. 2. The system shown in the figure may include a set of processors 302a, 302b, and 302c for executing one or more processes discussed herein. The set of processors 302 may be electrically coupled to one or more servers (e.g., computing systems) including memory 306a, 306b, and 306c that may store for example, program data, databases, and other forms of data. Each server of the one or more servers may also include one or more communication devices 308a, 308b, and 308c. The set of servers may provide a cloud-computing platform 310. In one embodiment, the set of servers includes different computing devices that are situated in different locations and may be scalable based on the needs and workflows associated with the resource site 200. The communication devices of each server may enable the servers to communicate with each other through a local or global network such as an Internet network. In some embodiments, the servers may be arranged as a town 312, which may provide a private or local cloud service for users. A town may be advantageous in remote locations with poor connectivity. Additionally, a town may be beneficial in scenarios with large networks where security may be of concern. A town in such large network embodiments can facilitate implementation of a private network within such large networks. The town may interface with other towns or a larger cloud network, which may also communicate over public communication links. Note that cloud-computing platform 310 may include a private network and/or portions of public networks. In some cases, a cloud-computing platform 310 may include remote storage and/or other application processing capabilities.

The system of FIG. 3 may also include one or more user terminals 314a and 314b each including at least a processor to execute programs, a memory (e.g., 316a and 316b) for storing data, a communication device and one or more user interfaces and devices that enable the user to receive, view, and transmit information. In one embodiment, the user terminals 314a and 314b is a computing system having interfaces and devices including keyboards, touchscreens, display screens, speakers, microphones, a mouse, styluses, etc. The user terminals 314 may be communicatively coupled to the one or more servers of the cloud-computing platform 310. The user terminals 314 may be client terminals or expert terminals, enabling collaboration between clients and experts through the system of FIG. 3.

The system of FIG. 3 may also include at least one or more resource sites 200 having, for example, a set of terminals 320, each including at least a processor, a memory, and a communication device for communicating with other devices communicatively coupled to the cloud-computing platform 310. The resource site 200 may also have a set of sensors (e.g., one or more sensors described in association with FIG. 2) or sensor interfaces 322a and 322b communicatively coupled to the set of terminals 320 and/or directly coupled to the cloud-computing platform 310. In some embodiments, data collected by the set of sensors/sensor interfaces 322a and 322b may be processed to generate a one or more resource models (e.g., reservoir models) or one or more resolved data sets used to generate the resource model which may be displayed on a user interface associated with the set of terminals 320, and/or displayed on user interfaces associated with the set of servers of the cloud computing platform 310, and/or displayed on user interfaces of the user terminals 314. Furthermore, various equipment/devices discussed in association with the resource site 200 may also be communicatively coupled to the set of terminals 320 and or communicatively coupled directly to the cloud-computing platform 310. The equipment and sensors may also include one or more communication device(s) that may communicate with the set of terminals 320 to receive orders/instructions locally and/or remotely from the resource site 200 and also send statuses/updates to other terminals such as the user terminals 314.

The system of FIG. 3 may also include one or more client servers 324 including a processor, memory, and communication device. For communication purposes, the client servers 324 may be communicatively coupled to the cloud-computing platform 310, and/or to the user terminals 314a and 314b, and/or to the set of terminals 320 at the resource site 200 and/or to sensors at the oil field, and/or to other equipment at the resource site 200.

A processor, as discussed with reference to the system of FIG. 3, may include a microprocessor, a graphical processing unit (GPU), a microcontroller, a processor module or subsystem, a programmable integrated circuit, a programmable gate array, or another control or computing device.

The memory/storage media discussed above in association with FIG. 3 can be implemented as one or more computer-readable or machine-readable storage media that are non-transitory. In some embodiments, storage media may be distributed within and/or across multiple internal and/or external enclosures of a computing system and/or additional computing systems. Storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. “Non-transitory” computer readable medium refers to the medium itself (i.e., tangible, not a signal) and not data storage persistency (e.g., RAM vs. ROM).

Note that instructions can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (arc) considered to be part of an article (or article of manufacture). The storage medium or media can be located either in a computer system running the machine-readable instructions, or located at a remote site from which machine-readable instructions can be downloaded over a network for execution.

It is appreciated that the described system of FIG. 3 is an example that may have more or fewer components than shown, may combine additional components, and/or may have a different configuration or arrangement of the components. The various components shown may be implemented in hardware, software, or a combination of both, hardware, and software, including one or more data processing and/or application specific integrated circuits.

Further, the steps in FIG. 7 described below may be implemented by running one or more functional modules in an information processing apparatus such as general-purpose processors or application specific chips, such as ASICs, FPGAs, PLDs, GPUs or other appropriate devices associated with the system of FIG. 3. For example, the flowchart of FIG. 7 below may be executed using a data engine or a data processing module (e.g., computing module) stored in memory 306a, 306b, or 306c such that the data engine/data processing module includes instructions that are executed by the one or more processors such as processors 302a, 302b, or 302c as the case may be. The various modules of FIG. 3, combinations of these modules, and/or their combination with general hardware are included within the scope of protection of the disclosure. While one or more computing processors (e.g., processors 302a, 302b, or 302c) may be described as executing steps associated with, for example, FIG. 7, the one or more computing device processors may be associated with the cloud-based computing platform 310 and may be located at one location or distributed across multiple locations. In one embodiment, the one or more computing device processors may also be associated with other systems of FIG. 3 other than the cloud-computing platform 310.

In some embodiments, a computing system is provided that includes at least one processor, at least one memory, and one or more programs stored in the at least one memory, such that the programs comprise instructions, which when executed by the at least one processor, are configured to perform any method disclosed herein.

In some embodiments, a computer readable storage medium is provided, which has stored therein one or more programs, the one or more programs including instructions, which when executed by a processor, cause the processor to perform any method disclosed herein. In some embodiments, a computing system is provided that includes at least one processor, at least one memory, and one or more programs stored in the at least one memory for performing any method disclosed herein. In some embodiments, an information processing apparatus for use in a computing system is provided for performing any method disclosed herein.

### Embodiments

In an exemplary implementation, the issues addressed by the disclosed methods and systems involves employing computing models to accurately and optimally provide responses or answers to questions or computing inputs. Thus, the disclosed models are beneficially configured to handle question and answer (e.g., QA) tasks. It is appreciated that in natural language processing, QA tasks involve computing operations that respond or provide answers to questions or some other computing inputs. According to one embodiment, the inputs or questions can comprise textual or auditory natural language inputs that are received by one or more input devices including microphones, keyboards, computing mice, touch screen displays, or some other graphical display computing devices. It is appreciated that at least two types of QA tasks are explored in this disclosure: in-context QA tasks; and open domain QA tasks. It is further appreciated that both types of tasks can test inference and generation quality of the Language Models (LMs).

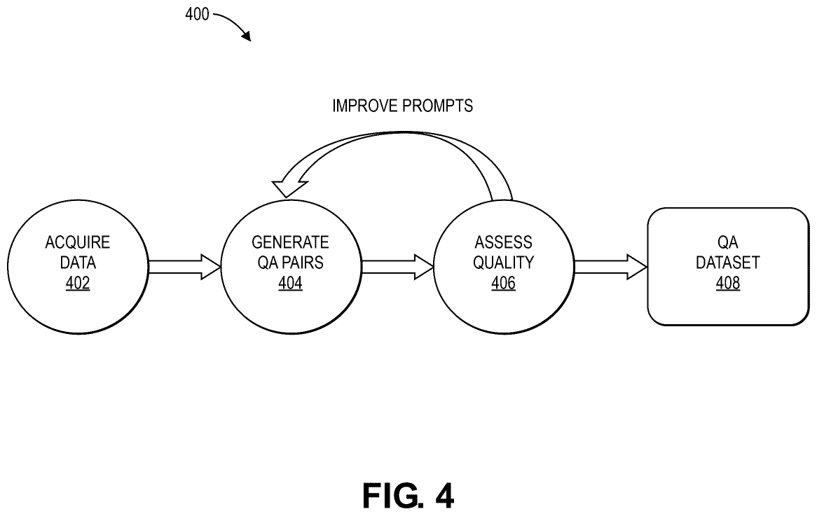

FIG. 4 shows a first exemplary flowchart 400 for generating a question and answer (QA) dataset.

At block 402 raw data may be acquired or otherwise received by a data processing engine. In one embodiment, the raw data comprises raw sensor data from a resource site, textual data, video data, audio data, training data, etc., which may or may not be associated with a resource site.

At block 404, the raw data is used by the data processing engine, to generate QA pairs which are subsequently assessed, at block 406 to determine the quality of the QA pairs. As shown in the figure, the QA pair generation at block 404 and the subsequent quality assessment at block 406 may be iterated multiple times (e.g., at least two times) to further improve the quality of the generated QA pairs. According to one embodiment, these iterations may be quantitatively and/or qualitative carried out on a set of QA pairs. This set of QA pairs (e.g., a small set of QA pairs) may be iteratively generated using various prompts that satisfy criteria associated with a plurality of different types of questions.

At block 408, the data processing engine may generate the QA dataset using the QA pairs that have undergone quality assessment at block 406 at least once.

### In-context QA Tasks vs Open Domain QA Tasks

The first type of the QA tasks (e.g., in-context QA tasks) involves configuring the LM to answer or respond to inputs (e.g., questions) based on a given passage of context. If the context does not provide an answer to the question, then the language model (LM) is adapted or configured to not produce an answer. In other words, the LM is configured, in such instances, not to just evaluate the input based on the LMs domain knowledge base but mostly on the LMs inference logic or contextual response generation capabilities. It is appreciated that the knowledge base can comprise an underlying set of fact data, assumptions data, and/or rules data associated with the LM and which allows the LM to provide responses to inputs.

In the second type of QA tasks (e.g., open domain QA tasks), there are little to no restrictions on the source of information leveraged to provide responses to inputs. Therefore, the answers or responses to the inputs can rely on the LMs quality of factual knowledge associated with generating responses to the inputs. Since the constraints are removed here, it becomes harder to control the outputs and therefore harder to evaluate said outputs or responses against ground truth data. In one embodiment, output generation and the factual knowledge features of the LM are decoupled to facilitate choosing in-context QA tasks. These aspects are further discussed below.

### Curating Domain-Specific and Task-Specific Datasets Using Instruction Following LLMs

The methodology for analyzing, managing, and curating task-specific energy domain datasets can include using energy data associated with a plurality of domains including, for example: an upstream domain related to exploring and/or developing energy; a midstream domain associated with the transportation and storage of energy; and a downstream domain related to refining and/or distributing energy. sources to generate our own dataset. In some embodiments, data sources associated with the foregoing domains include public energy data sources. Exemplary public energy data sources include data derived from the National Offshore Petroleum Information Management System (NOPIMS) data sources, the Division of Oil, Gas, and Geothermal Resources (DOGGR) data sources, Petrowiki data sources, and custom data sources. These exemplary data sources are provided as examples and do not limit implementing the disclosed solution using a plurality of other public or nonpublic data sources.

In some embodiments, data from one or more of the data sources can comprise homogeneous and nonhomogeneous data that have been formatted or otherwise adapted for testing LLMs in a plurality of contexts. In some cases, the LLMs are stress-tested to determine optimality of the results generation capabilities of the LLMs for the plurality of contexts.

### Data Generation

According to some embodiments, the following two data problems associated with data generation are addressed using the disclosed techniques:
1. Knowing how well the LLM can handle the data, so there may be problems with quality.
2. Optimally determining which domain or which combination of domains to leverage for a given LLM to benchmark against or for a specific task or domain.

To address these problems, a hybrid solution is proposed for the disclosed solution: the LLM generates a raw dataset which are computationally customized by Subject Matter Experts (SMEs) to filter out data generations that are inconsistent with a given energy development strategy. This ensures that data quality is dynamically monitored or otherwise calibrated or configured using SME expertise.

### LM or LLM Training Data or Domain Data Generation

To generate the dataset, raw data (e.g., raw textual data, image data, or video data) associated with one or more domains is received. In one embodiment, the raw data may be scraped or otherwise aggregated from textual, audio, or video data derived from: one or more sensors deployed at a resource site; bibliographic data including report data associated with a resource site; bibliographic data that is not derived from the resource site, etc.

Furthermore, the aggregated data may be chunked or organized into layered data having one or more layers (e.g., layers and sub-layers) or chapters (e.g., chapters and sub-chapters) in order to limit a context length for the LM or LLM. An exemplary context length may be less than, equal to, or greater than 4000 tokens per layer size or chapter size depending on the implementation. For example, the context length may indicate an amount of text associated with one or more tokens (e.g., data tokens) that an AI model can process and remember at any given point in time. In some embodiments, the disclosed LLM can process a data input and/or data output in the form of tokens, which can comprise words, sub-words, or textual data characters. It is appreciated that natural language tasks can employ a tokenizer which breaks words (e.g., words associated with a language) into appropriate tokens for processing by one or more LLMs provided in this disclosure.

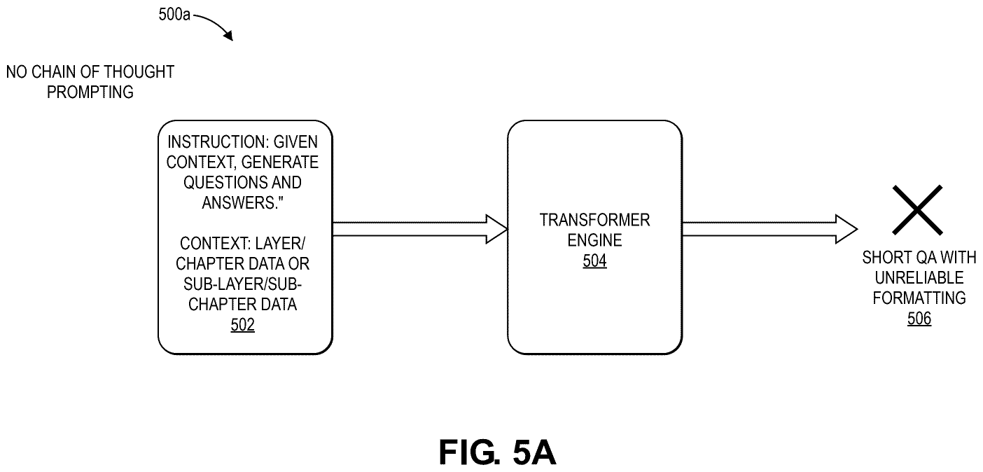

In addition, each chapter or sub-chapter and/or layer or sub-layer may be independently tested using the LM or LLM to determine model performance data and/or quality assessment data for the LM or LLM. In other embodiments, two or more layers or sub-layers and/or chapters or sub-chapters may be tested in aggregate using the LLM to determine performance data and/or quality assessment data for the LM or LLM. These aspects are indicated in FIGS. 5A and 5B, for example. In particular, FIG. 5A shows an implementation 500a where the layered data 502 is directly applied to the transformer engine (e.g., GPT engine) which leads to unreliable results (e.g., unreliably formatted results) 506. In contrast, FIG. 5B shows an implementation 500b where the layered data 502 is not only fed to a first transformer engine 508, but the output of the first transformer engine 508 is used to generate technical questions with attendant answers 512 which are subsequently fed to a second transformer engine 510. It is appreciated that the second transformer engine 510 can be used to generate a more detailed question and answer (QA) outputs 512 reliably (e.g., reliable QA formats).

Since LLMs require prompt (e.g., real-time or near real-time) engineering for reliable outputs, quality assessment is an important step in the analysis of a given LM or LLM. Through iterative improvements in prompting, the quality of generation output data by the LM or LLM can be boosted significantly. In one embodiment, the generated performance data or quality assessment data may be used to determine whether the raw data is suitable to represent training data or source of truth data for the LM or LLM.

### Prompt Engineering: Chain of Thought/Intent Data Prompting

Chain of thought/intent data prompting can be a useful prompt engineering tool, where the prompt is designed in a way that the LLM is provided “time to think,” analyze, or otherwise process an input before generating an answer or output data. What this means is that the LLM is prompted to do some intermediate tasks that help inform the final answer or response provided or generated by the LM and the LLM. This can significantly improve performance LM or LLM.

In the case of the raw data disclosed herein, a two-prong computing operation is applied to the raw data: first, instead of directly jumping into a QA computing operation or a QA tasks, the LLM is asked to categorize a context (e.g., leverage context data associated with the raw data) into one of a plurality of designated categories that may be selected or chosen to reflect data groupings relevant to one or more domains associated with energy development. The LM or LLM is then asked to generate a first set of QA tasks. Second, the LM or LLM may be asked to improve upon its output generations by being prompted to provide a set of “more technical questions.” In some embodiments, the LM or LLM may be prompted to generate a plurality (e.g., at least 3, or at least 4, or at least 5, etc.) answers or output data in order to indicate its stochasticity and provide the SMEs with more options to choose from.

### Prompt Engineering: Formatting Instructions

To make data generation (e.g., responses or answers) from the LM or LLM usable, there is in need to determine a format for said data generations. According to one embodiment, a JavaScript Object Notation (JSON) format is used by the LM or LLM for the data generations or the generation of QA pairs with the structure and keys of the QA pairs being specified as the case may require. Other exemplary formats used by the LM or LLM include an Extensible Markup Language (XML) format, a Comma-separated values (CSV) format, etc. This makes the data generation significantly more uniform and usable for downstream tasks.

It is appreciated that LLMs are sometimes unable to completely follow instructions in the first attempt. As such a retry logic may be implemented using the data processing engine where the LM or LLM is provided with an error message that is generated or returned from parsing an input string having, for example, one of the foregoing formats (e.g., JSON format). In embodiments where there are multiple retry fails, datapoints associated with said inputs are flagged for optimization and/or exclusion from the QA dataset.

### Generation of Benchmarked Dataset (Human Data Annotation)

Once a raw QA dataset is generated, it can be transmitted to one or more subject-matter experts (SMEs) and/or an optimization engine comprised in the data processing mentioned above for verification. According to one embodiment, the one or more SMEs and/or the optimization engine may analyze, verify, or confirm the raw QA dataset determining whether:
1. Each QA pair comprised in the raw dataset is associated with inquiry data indicating a question suitable for a test case (e.g., closed-book exam).
2. Any of the answers corresponding to the inquiry data or question is accurate or correct given context data.
3. Any of the answers suitably detailed or indicate a comprehensive response data.

According to one embodiment, response data associated with the question or inquiry data can include one or more candidate answers (e.g., at least 3, 4, 5, or 6 candidate answers) or response data. The one or more candidate answers or response data may be categorized or otherwise rated or ranked to indicate stronger responses or answers comprised in the response data and thereby indicate marked or ranked answers. Based on the response data, QA pairs which fall below threshold data associated with the one or more candidate answers may be filtered out. After filtering, a plurality of questions (e.g., at least 20, or at least 50, or at least 100, or at least 127 questions) that meet the standards associated with the filtering or that fall within or above the threshold data are mapped to at least one correct answer. Moreover, hallucination data may be generated using the following data augmentation technique:
Replace context data for each question using a different context of the same category. As some questions are not directly related to the context comprised in the context data, the model (e.g., LM or LLM) may be expected to produce no answer for such scenarios. In an exemplary implementation, the total number of questions associated with the dataset is 254.
Conduct an annotation operation validates and confirms the reliability and/or accuracy of the model. It is appreciated that this validation and confirmation of the model beneficially accounts for the hazardous and catastrophic consequences that can result from not having an optimal model.

### Evaluation Techniques for Using Benchmarked Datasets for Other Models

According to some embodiments, evaluation metrics may be applied during the validation and/or benching computing operations disclosed. For example, the evaluation metrics include one or more scoring techniques including a first scoring technique and a second scoring technique.

### First Scoring Technique

The first scoring technique, according to one embodiment, uses an n-gram or a word-level matching between predictions and references associated with a given QA dataset. For example, the first scoring technique includes a bilingual valuation understudy (BLEU) computing process that BLEU measures the number of n-grams in the prediction text associated with the QA dataset and which also appear in a reference text comprised in input data applied to the QA dataset. In particular, BLEU may be used to measure or determine precision data for the QA dataset by computing a geometric average of modified n-gram precisions, pₙ, based on n-grams up to length N and positive weights wₙ summing to one. Next, let c be the length of the candidate translation and r be the effective reference corpus length. Based on the foregoing, a brevity penalty BP may be given by:

$$BP = \{ \begin{matrix}1 , & c > r \\ {e}^{( 1 - \frac{r}{c} )} , & c \geq r\end{matrix}$$

Based on the above equation, BLEU can be expressed as:

$$BLEU = BP \times exp ( {\sum }_{n = 1}^{N} {w}_{n} log {p}_{n} )$$

According to one embodiment, the first scoring technique involves a recall-oriented understudy for gisting evaluation (ROUGE) which measures the number of n-grams that appear in a reference text associated with an input and/or the QA dataset such that the reference text also appears in a prediction or answer generated using the QA dataset. This can be viewed as a metric of recall:

$$ROUGE - N = \frac{{\sum }_{S ∈ \{ Reference Summaries \}} {\sum }_{{gram}_{n} ∈ \{ Reference Summaries \}} {Count}_{match} ( {gram}_{n} )}{{\sum }_{S ∈ \{ Reference Summaries \}} {\sum }_{{gram}_{n} ∈ \{ Reference Summaries \}} {Count}_{match} ( {gram}_{n} )} ,$$

where n stands for the length of the n-gram, gramₙ, while (gramₙ) is the maximum number of n-grams co-occurring in a candidate summary and a set of reference summaries.

According to one embodiment, an F1 metric may be applied to the one or more embodiments of the disclosed datasets such that the F1 metric is used to determine harmonic mean data indicating precision and/or recall information that characterize the performance of an LM or an LLM. In some cases, the F1 metric is applied in a bag-of-words fashion where the ordering of words is discarded when calculating or determining the matching of word frequencies.

According to some embodiments, the foregoing metrics are based on data matching or data relationship computing operations and thereby demonstrate trend data at a corpus level of the QA dataset. As such there is a need to further enhance the predictive abilities of LMs or LLMs by leveraging semantic and/or syntactic information associated with data inputs and/or data comprised in the QA dataset.

### Second Scoring Techniques

According to one embodiment, the second scoring technique comprises a model-based scoring computing operation that leverages semantic answer similarity data. This can involve correlating and/or comparing text embeddings of predictions to generate the similarity data such that the similarity data indicates a similarity between reference answers. For example, the reference answers comprise answers that have already been validated and designated as ground truth answers or benchmark answers.

However, this method is not sensitive to small grammatical shifts such as negation (using “not”). For example, if the reference answer is “Company A is a great place to work” then it is highly likely that the (incorrect) prediction “Company A is not a great place to work” will be accepted as correct.

This lack of grammatical understanding makes this method unsuitable for semantic evaluation. However, this method may be very useful for semantic search and is often used in vector databases.

### LLM-based Scoring or Evaluation

According to one embodiment, the disclosed LLM approach can be used to evaluate the correctness of responses. This may entail, for example, asking the LLM, given an appropriate context and a reference answer, whether the predicted answer is correct. This verification, according to some implementations, can be less computation intensive and can leverage the LLM to generate the necessary evaluation data. Such an LLM may be regarded as an “Examiner LM” since this LM poses questions and verifies answers. In order to impart more knowledge data into the process, an answer is marked or otherwise designated as being correct if it matches at least one reference (e.g., annotated reference) and is entailed by the context.

While some LMs can be a bit unreliable at times, the disclosed evaluation approach overall can provide insightful data trends characterizing the performance between different candidate LMs. In addition, the disclosed evaluation approach can be easily scalable when compared to other annotation techniques for checking an answer. For example, using a given dataset (e.g., petrowiki dataset), the disclosed Examiner LM can evaluate all response combinations associated with said data in less than 5 minutes or less than 10 minutes, or less than 11 minutes depending on the implementation.

According to one embodiment, results associated with the disclosed LLM can be made more reliable by:
Asking the LLM to explain its reasoning or rationale for why it thinks the predicted answer is correct or not. This follows a “chain of thought data prompting” technique discussed above. This has two benefits including: enable the LLM to provide more accurate answers; and allowing the inspection of the workings of the LLM and thereby facilitate optimal model debugging and/or qualitative analysis.
Determining whether the LLM had trouble in cases where either: the predicted answer was empty or whether there were no reference answers for the LLM. It is appreciated that such evaluation approaches are not only straight forward (e.g., straight forward with regards to marking correct answers only if both an answer and its reference answers are empty), but also facilitate separating branches of the LLM by configuring or asking the LM to check specifically for a response's accuracy. For example, if the reference answers are empty, the LM can be configured to provide only the predicted answer, and be asked to mark responses as correct if and only if the predicted answer is empty, or provide a response indicating a lack of sufficient context for an answer prediction or an indication of a “no” feedback as the case may require. This check beneficially enables the LM to not generate empty strings as outputs in complex model computation scenarios.

According to one embodiment, two datasets were selected and the evaluation techniques applied to same. For the two datasets, a generative pre-trained transformer (e.g., GPT-4) and a multi-lingual language model (e.g., PaLM-2) were used to develop candidate models. In an exemplary embodiment, the metrics used to measure the performance of the developed LM include: BLEU; ROUGE-L (longest common subsequence); and F1 including F1 (A)—questions with answers, and F1 (NA)—questions with no answer associated with the number of Exact Matches.

### Data Flow

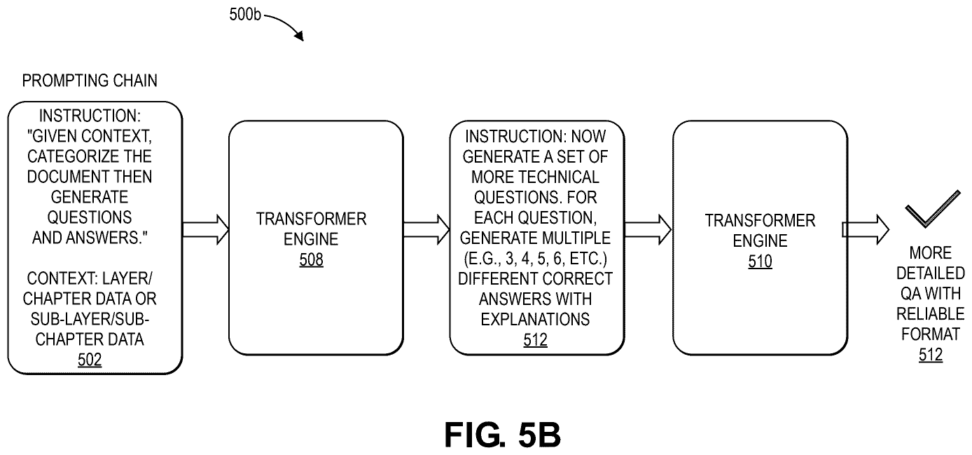

FIG. 6 provides an exemplary dataflow diagram 600 for generating insight data. Context data and/or aggregated data 602 associated with a resource site may be applied to a first language model 604 (e.g., energy development model). In one embodiment, the context data and/or the aggregated data 602 may independently or in combination comprise a QA dataset.

In response to applying the context data and/or the aggregated data 602 to the first language model 604, one or more data predictions 606 may be generated. According to one embodiment, qualitative analysis computing operations 608 may be applied to the data predictions to generate a first aspect of the insight data 618. Furthermore, quantitative analysis computing operations may be applied to the data predictions 606 using, for example, a scoring engine 610 and/or a second language model 612. It is appreciated that the scoring engine may be used to generate bilingual valuation understudy (BLEU) data 614 while the second language model 612 may be used to generate a correctness score 616 for the model predictions. As shown in this figure, the BLEU data 614 and the correctness score 616 may constitute a second aspect of the insight data 618. In particular, first aspect of the insight data, which comprises qualitative performance data generated based on the qualitative analysis computing operations 608 may be combined with the he BLEU data 614 and the correctness score 616 (second aspect of the insight data 618) to generate the entirety of the insight data 618.

### Detailed Workflow

FIG. 7 shows an exemplary workflow 700 for generating benchmark datasets for energy development models. It is appreciated that a data engine stored in a memory device may cause a computer processor to execute the various stages of the workflow 700. For example, the disclosed techniques may be implemented as a data engine of a computing platform associated with a geological software tool such that the data engine enables optimally implementing a plurality of computing models associated with surface and/or subsurface characteristics and/or structures associated with a resource site.

At block 702, the data engine may structure energy data to be applied to an energy development model and thereby generate a first dataset. According to one embodiment, the first dataset comprises structured energy data indicating at least technical information or technical computations associated with developing an energy resource at a resource site.

Turning to block 704, the data engine may determine a first energy development model to which may be applied the first dataset. The first energy development model may comprise a computing model such as a large language model.

At block 706, the data engine may apply, based on structuring the energy data, the first dataset to the first energy development model and thereby generate a first set of model predictions by the first energy development model. According to one embodiment, applying the first dataset to the first energy development model may comprise executing a computing simulation where the first computing model is tested using the first dataset and thereby generate the model predictions. The model predications, for example, may comprise model output data generated based on executing the computing simulation.

According to one embodiment, the data engine determines, using a second energy development model that is different from the first energy development model, quantitative performance data for the first energy development model as indicated at block 708. It is appreciated that the quantitative performance data can include a first set of quantitative metrics that indicate congruency between the first dataset and the first set of model predictions.

At block 710, the data engine may generate, based on the first set of model predictions, qualitative performance data for the first energy development model. The qualitative performance data, for example, may indicate: contextual performance data that are non-quantitative, or an ability of the first energy development model to adaptively predict data outputs based on specific data inputs associated with the first dataset; or frequency data associated with applying said specific data inputs to the first energy development model; or a logical relationship indicating the quality of data predictions associated with said specific data inputs.

At block 712, the data engine may combine the quantitative performance data with the qualitative performance data and thereby generate insight data. According to one embodiment, the insight data indicates one or more of: a report indicating textual or image data that provide performance information of the first energy development model; and a model optimization strategy that drives updating the first dataset to generate a second dataset that improves the performance of the first energy development model.

Turning to block 714, the data engine may deploy, a second dataset generated based on the insight data for use by the first energy development model or a third energy development model and thereby generate energy development data including at least one of: upstream domain data associated with exploring and producing energy; midstream domain data associated with transporting and storing energy; and/or downstream domain data associated with refining energy.

In other embodiments, a system and a computer program can include or execute the method described above. These and other implementations may each optionally include one or more of the following features.

Structuring the energy data can comprise formatting the energy data to constitute one or more of: one or more question-answer pairs associated with the energy data; and contextual data elements. In one embodiment, the contextual data elements are associated with the energy data and link one or more question-answer pairs to one or more of: an input applied to the first energy development model or the third energy development model; and/or reference data that inform responses or point to the one or more question-answer pairs based on context data comprised in, or associated with the input applied to the first energy development model or the third energy development model.

It is appreciated that the input applied to the first energy development model or the second energy development model comprises a natural language input.

It is further appreciated that the natural language input comprises syntactic or semantic data parameters that characterize the natural language input. In one embodiment, the semantic or syntactic data may include a logical flow or an arrangement of one or more words comprised in the input.

Moreover, the quantitative performance data comprises one or more of: bilingual valuation understudy (BLEU) data; and recall-oriented understudy for gisting evaluation (ROUGE) data.

In some cases, the second energy development model comprises an examiner language model configured to determine a percentage of answers comprised in the first set of predictions that is accurate in response to applying the first dataset to the first energy development model.

In some embodiments, the qualitative data indicates at least one of: a degree of accuracy with which the first energy development model formats data elements comprised in the first set of predictions; and an ability of the first energy development model to correctly determine accurate context data associated with an input applied to the first energy development model.

In some instances, the first dataset or the second dataset comprises data layers that indicate the energy data such that each data layer includes at least one sub-layer.

According to some embodiments, the data layers limit a context length of the first energy development model or a context length of the third energy development model.

Moreover, the context length may be less than or equal to 4000 tokens per layer size of each data layer comprised in the data layers.

In some cases, generating the qualitative performance data for the first energy development model comprises assessing, based on a ground truth dataset, a first set of model predictions or a second set of model predictions by the first energy development model.

In exemplary implementations, the second energy development model is tuneable or configurable based on one or more of: a use-case associated with first energy domain; a user-specific configuration; a resource-site specific computational or noncomputational setup; or a combination of data relationships between the first energy domain and a second energy domain.

### Benchmarking and Evaluation of LLMs for Geoscience Domain

### System Overview

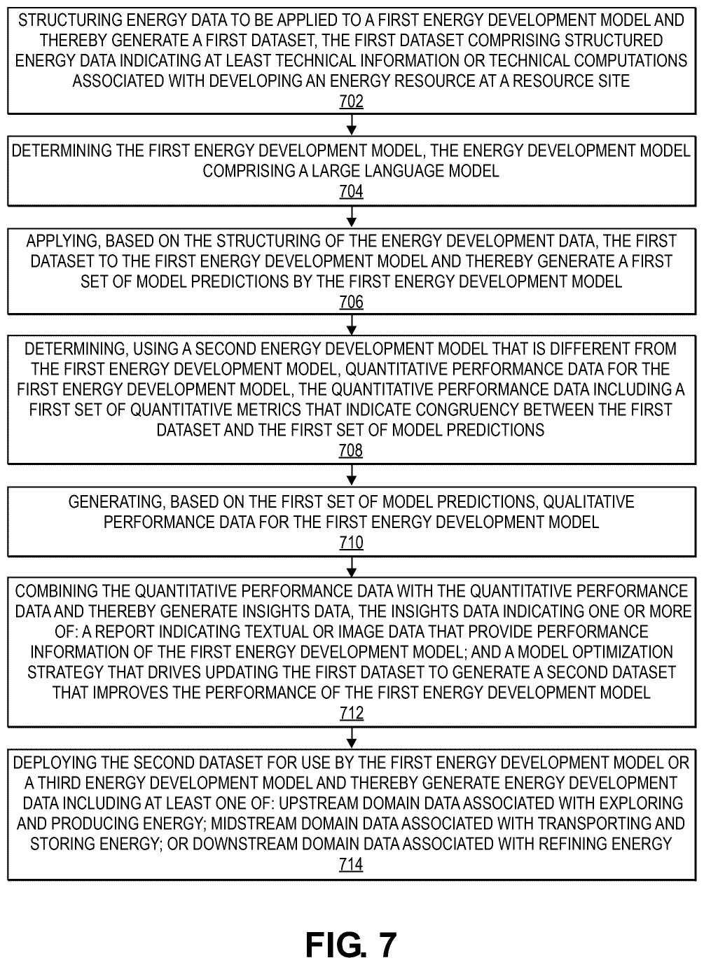

FIG. 8 illustrates an example of a system 800 that includes various management components 810 to manage various aspects of a geologic environment 850 (e.g., an environment that includes a sedimentary basin, a reservoir 851, one or more faults 853-1, one or more geobodies 853-2, etc.). For example, the management components 810 may allow for direct or indirect management of sensing, drilling, injecting, extracting, etc., with respect to the geologic environment 850. In turn, further information about the geologic environment 850 may become available as feedback 860 (e.g., optionally as input to one or more of the management components 810).

In the example of FIG. 8, the management components 810 include a seismic data component 812, an additional information component 814 (e.g., well/logging data), a processing component 816, a simulation component 820, an attribute component 830, an analysis/visualization component 842 and a workflow component 844. In operation, seismic data and other information provided per the components 812 and 814 may be input to the simulation component 820.

In an example embodiment, the simulation component 820 may rely on entities 822. Entities 822 may include earth entities or geological objects such as wells, surfaces, bodies, reservoirs, etc. In the system 800, the entities 822 can include virtual representations of actual physical entities that are reconstructed for purposes of simulation. The entities 822 may include entities based on data acquired via sensing, observation, etc. (e.g., the seismic data 812 and other information 814). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 820 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 8, the simulation component 820 may process information to conform to one or more attributes specified by the attribute component 830, which may include a library of attributes. Such processing may occur prior to input to the simulation component 820 (e.g., consider the processing component 816). As an example, the simulation component 820 may perform operations on input information based on one or more attributes specified by the attribute component 830. In an example embodiment, the simulation component 820 may construct one or more models of the geologic environment 850, which may be relied on to simulate behavior of the geologic environment 850 (e.g., responsive to one or more acts, whether natural or artificial). In the example of FIG. 8, the analysis/visualization component 842 may allow for interaction with a model or model-based results (e.g., simulation results, etc.). As an example, output from the simulation component 820 may be input to one or more other workflows, as indicated by a workflow component 844.

As an example, the simulation component 820 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 810 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 810 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 8 also shows an example of a framework 870 that includes a model simulation layer 880 along with a framework services layer 890, a framework core layer 895 and a modules layer 875. The framework 870 may include the commercially available OCEAN® framework where the model simulation layer 880 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 8, the model simulation layer 880 may provide domain objects 882, act as a data source 884, provide for rendering 886 and provide for various user interfaces 888. Rendering 886 may provide a graphical environment in which applications can display their data while the user interfaces 888 may provide a common look and feel for application user interface components.

As an example, the domain objects 882 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 8, data may be stored in one or more data sources (or data stores, generally physical data storage devices), which may be at the same or different physical sites and accessible via one or more networks. The model simulation layer 880 may be configured to model projects. As such, a particular project may be stored where stored project information may include inputs, models, results and cases. Thus, upon completion of a modeling session, a user may store a project. At a later time, the project can be accessed and restored using the model simulation layer 880, which can recreate instances of the relevant domain objects.

In the example of FIG. 8, the geologic environment 850 may include layers (e.g., stratification) that include a reservoir 851 and one or more other features such as the fault 853-1, the geobody 853-2, etc. As an example, the geologic environment 850 may be outfitted with any of a variety of sensors, detectors, actuators, etc. For example, equipment 852 may include communication circuitry to receive and to transmit information with respect to one or more networks 855. Such information may include information associated with downhole equipment 854, which may be equipment to acquire information, to assist with resource recovery, etc. Other equipment 856 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 8 shows a satellite in communication with the network 855 that may be configured for communications, noting that the satellite may additionally or instead include circuitry for imagery (e.g., spatial, spectral, temporal, radiometric, etc.).

FIG. 8 also shows the geologic environment 850 as optionally including equipment 857 and 858 associated with a well that includes a substantially horizontal portion that may intersect with one or more fractures 859. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 857 and/or 858 may include components, a system, systems, etc. for fracturing, seismic sensing, analysis of seismic data, assessment of one or more fractures, etc.

As mentioned, the system 800 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

The present disclosure describes a framework for benchmarking domain-specific LLMs. Thus, the method includes or uses a domain-specific benchmarking dataset. More particularly, the method may include developing an automated pipeline for creation of domain-specific datasets with tasks ranging from generic question-answering and image analysis to more specialized use cases such as seismic interpretation, well log interpretation, etc. The method also includes or provides multimodality. More particularly, it incorporates diverse data types such as seismic images, well logs, production data, and technical reports to enable multi-modal learning and more comprehensive insights. The method also includes or uses domain-specific metrics. Thus, the method moves beyond general language modeling metrics and develops evaluation metrics specifically tailored to the unique tasks and challenges of the oil and gas industry.

The method creates a high-quality domain-specific benchmarking dataset with relevant tasks that may provide a meaningful evaluation. The method leverages LLMs to automatically generate diverse and challenging questions and answers based on a few shot examples in the provided context.

At a high level, the benchmark dataset creation process involves starting with a set of tasks along with manually crafted examples for those tasks. These few-shot examples serve as inputs to a multimodal model (e.g., pre-trained or fine-tuned), which leverages them to create new question-answer (QA) pairs. The new QA pairs are validated through an expert-in-the-loop evaluation, which expands them using techniques such as paraphrasing and data augmentation.

### Benchmark Dataset Creation

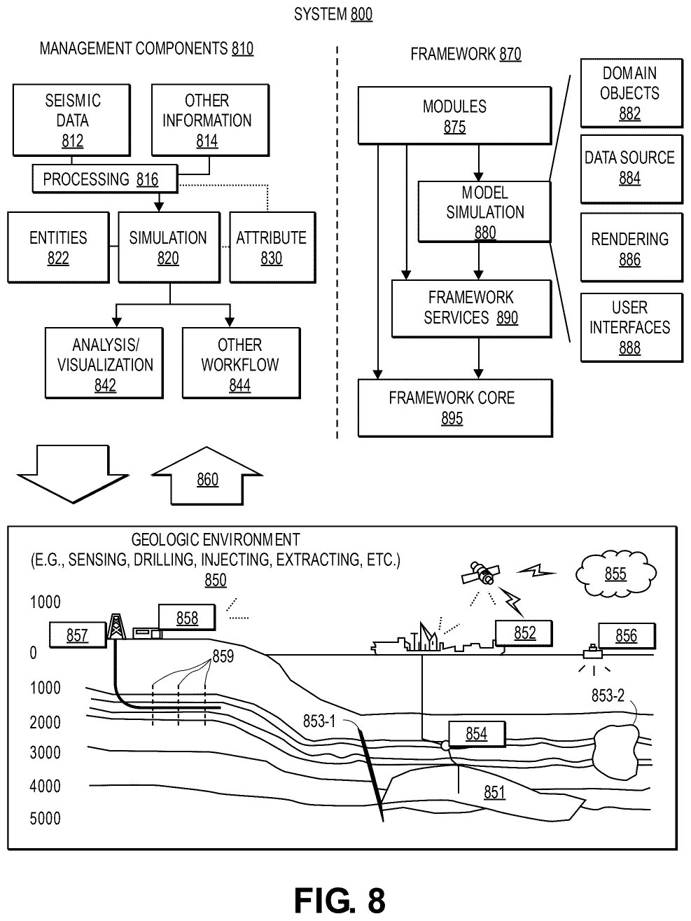

FIG. 9 illustrates a flow diagram for a benchmark dataset creation process, according to an embodiment. For the benchmarking dataset creation, the method leverages the following set of domain-specific tasks and data sources to evaluate the LLMs and multimodal models.

### List of Domain-Specific Tasks

Question-Answering: Extracting relevant information from scientific literature and reports to answer specific questions about geological phenomena, reservoir characteristics, and exploration and production activities.
Image Analysis: Identifying rock types, faults, and geological structures from satellite imagery, aerial photographs, and core samples.
Seismic Data Interpretation: Analyzing seismic reflection data to map subsurface structures and identify potential hydrocarbon reservoirs.
Well Log Interpretation: Extracting information from well logs to characterize reservoir properties for optimizing drilling operations.
Reservoir Simulation: Modeling and predicting the behavior of subsurface reservoirs based on visual and textual data.

### Data Sources

Domain-specific texts such as books, scientific publications, reports, and geological maps
Product training manuals and help documentation.
Geophysical surveys such as 2D and 3D seismic data
Well logs with information about relevant properties such as lithology, porosity, permeability, etc.

The domain-specific dataset, thus created, is in the form of (e.g., Ground Truth Context, Question, Answer) triplets using unstructured text and image data from the data sources obtained. For textual data sources, such as books, scientific publications, reports, and training manuals, the data may be first pre-processed and converted into a unified markdown format and split into semantically meaningful chunks based on the document title and section header information. These document chunks may be provided as inputs to a multimodal model and serve as ground truth contexts for the question answers pair generation. The context and QA pairs thus generated may be (e.g., manually or automatically) evaluated by subject matter experts and added to the pool of a few examples for generating additional examples.

### Evaluation Methodology

Recent advancements utilize LLMs themselves to evaluate RAG system outputs, enabling more sophisticated and human-like assessments. For example, a framework for evaluating retrieval augmented generation (RAG) systems may implement LLM-based evaluations. In an example, it may define the following metrics to evaluate generation and generation components.
Answer Relevancy (Generation): Assesses the relevance of the generated answer to the user's question.
Faithfulness (Generation): Determines whether the generated answer is grounded in the provided context and avoids hallucinations.
Answer correctness: Measures the generated answer's factuality and semantic similarity concerning the ground truth answer.
Context Precision (Retrieval): Measures the relevance of the retrieved context to the user's question.
Context Recall (Retrieval): Evaluates whether the information for answering the question is present in the retrieved context.

To enable the evaluation of images within contexts or input queries for generic question answering tasks (e.g., with or without retrieval), the method may extend the framework to leverage evaluation metrics from multimodal models (e.g., Gemini, GPT-4o family of models) as opposed to language models.

For specialized image analysis and seismic interpretation tasks involving identification of geological features, the method may rely on standard classification metrics such as accuracy, precision, recall, and F1-score.

Thus, the method may provide a standardized framework for companies to select the most suitable LLM, based on objective performance metrics. The method creates a domain-specific benchmarking dataset for tasks ranging from generic question-answering and image analysis to more specialized use cases such as seismic interpretation, well log interpretation, etc. It also incorporates diverse data types such as seismic images, well logs, production data, and technical reports to enable multi-modal learning and more comprehensive insights.

The method may evaluate domain-specific models and benchmark them on specialized tasks that are most relevant to the energy and geoscience domains as opposed to using general benchmark datasets. The method may also create additional task-specific datasets. The benchmarking dataset may be used to evaluate other LLMs and multimodal models on domain-specific tasks. In addition, the method may be adopted to create domain-specific specialized tasks.

### Exemplary Method

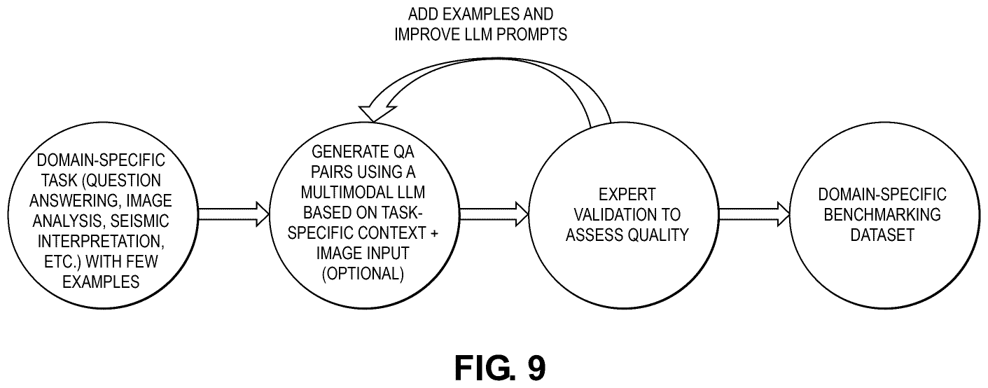

FIG. 10 illustrates a flowchart of a method 1000 for creating a domain-specific benchmarking dataset for a domain-specific task in an oil and/or gas domain, according to an embodiment. An illustrative order of the method 1000 is provided below; however, one or more portions of the method 1000 may be performed in a different order, simultaneously, repeated, or omitted. At least a portion of the method 1000 may be performed using a computing system.

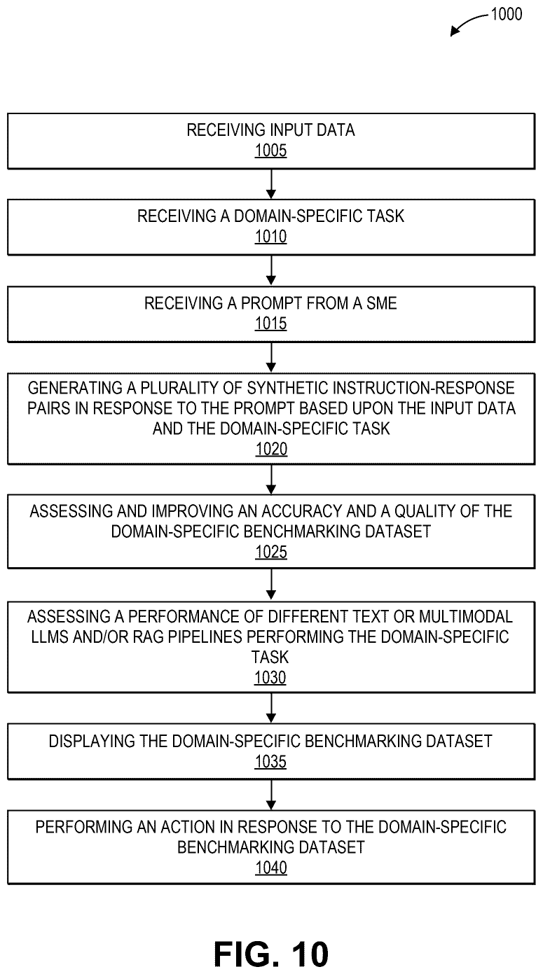

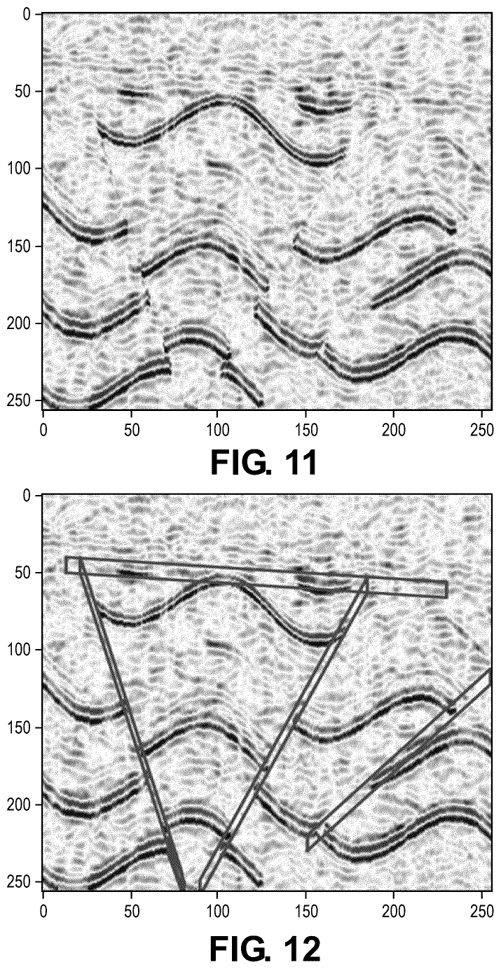

The method 1000 includes receiving input data, as at 1005. The input data may include annotations. FIG. 11 illustrates an example of the input data (e.g., a seismic image), and FIG. 12 illustrates an example of annotations in the seismic image, according to an embodiment. The annotations may be related to features in the input data, types of the features, numbers of the features, locations of the features, relative positions between the features, values of the features, inferences determined based upon the features and the values, or a combination thereof. The features may be or include geological structures or subsurface properties. The geological structures may be or include faults, unconformities, dips, folds, or a combination thereof. The subsurface properties may be or include lithology, porosity, fluid type, reservoir zones, or a combination thereof. The values may be or include seismic attributes or well log measurements. The seismic attributes may be or include amplitude, noise, frequency, dip, azimuth, coherence, or a combination thereof. The well log measurements may be or include gamma ray, resistivity, density, neutron porosity, sonic travel time, water saturation, or a combination thereof. The inferences may be or include structural interpretation, stratigraphic interpretation, lithology identification, reservoir characterization, or a combination thereof.

The input data with the annotations may serve as a ground truth. The annotations may be received from a user that is a subject matter expert (SME). The input data may be sourced from real-world and/or simulated environments. The input data may be sourced from structured and/or unstructured data including oil and/or gas textbooks, portable document format (PDF) documents, webpages, geophysical surveys, well logs, scientific publications, geological reports, or maps. The input data may be in text format, tabular format, graphical format, mathematical format, image format, or a combination thereof. The input data in the image format may include a seismic image.

The method 1000 may also include receiving the domain-specific task, as at 1010. The domain-specific task may be or include question answering, report generation, summarization, image captioning and analysis, measurement log analysis, or a combination thereof. The domain- specific task may be related to the oil and/or gas domain. The oil and/or gas domain may include petroleum engineering, seismic interpretation, well log interpretation, drilling, production, reservoir simulation, or a combination thereof. The domain-specific task may include a plurality of examples.

The method 1000 may also include receiving a prompt from the SME, as at 1015. The prompt may be received by a text or multimodal large language model (LLM).

The method 1000 may also include generating a plurality of synthetic instruction-response pairs in response to the prompt based upon the input data and the domain-specific task, as at 1020. The synthetic instruction-response pairs may be or include question-answer pairs, image-caption pairs, image-annotation pairs, input-summary pairs, multi-turn conversation-response pairs, or input-analysis pairs. The synthetic instruction-response pairs may be created by the text or multimodal LLM. The synthetic instruction-response pairs may form at least part of the domain-specific benchmarking dataset.

The method 1000 may also include iteratively assessing and improving an accuracy and a quality of the domain-specific benchmarking dataset based upon feedback from domain-specific models or the SME, as at 1025.

The method 1000 may also include assessing a performance of different text or multimodal LLMs and/or retrieval augmented generation (RAG) pipelines performing the domain-specific task, as at 1030. The performance may be assessed by comparing responses from the different text or multimodal LLMs and/or RAG pipelines to the domain-specific benchmarking dataset.

The method 1000 may also include displaying the domain-specific benchmarking dataset, as at 1035.

The method 1000 may also include performing an action in response to the domain-specific benchmarking dataset, as at 1040. More particularly, a user may submit an instruction (e.g., question) to the text or multimodal LLM, and the text or multimodal LLM may generate a response based upon the domain-specific benchmarking dataset. The action may be based upon and/or in response to the response from the text or multimodal LLM. For example, action may be or include the text or multimodal LLM generating and/or transmitting a signal (e.g., using a computing system) that recommends, instructs, or causes a physical action to occur at a wellsite. The action may also or instead include performing the physical action at the wellsite. The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

An evaluation framework may also be used to assess the performance of different multimodal models and Retrieval Augmented Generation (RAG) pipelines on domain-specific tasks created in the domain-specific benchmarking dataset. The framework extends the popular RAGAS framework to incorporate the multimodality of domain data and includes additional domain-specific metrics for each task.

### Example Prompt Template

You are an experienced seismic interpreter. What you are provided is a json file with different features and an interpretation of a seismic image, describing the same image you are looking at. Answer the questions as you are seeing the image.

Design a conversation between you and a person asking about this photo. The answers should be in a tone that a visual AI assistant is seeing the image and answering the question. Ask diverse questions and give corresponding answers. Include questions asking about the visual content of the image, including the object types, counting the objects, object actions, object locations, relative positions between objects, etc. Include questions that have definite answers:
(1) one can see the content in the image that the question asks about and can answer confidently; and
(2) one can determine confidently from the image that it is not in the image. Do not ask any question that cannot be answered confidently.

The user questions could be vague or specific. The answers from AI assistant can be specific and may include specific values of start/end coordinates for fault or unconformity segments. The names of fault (e.g., “Fault 0, “Fault 1”) and unconformities (“Unconformity 0”, “Unconformity 1”) are just representative and do not mean anything. So, do not use the specific names in the caption.

The numerical values or ranges of noise and frequency do not have meaning for the user and should not be used to create any question or assistant. Do not use the numerical values or ranges of noise and frequency, only the classes values (e.g., low, medium, high). If frequency value is less than 45, the frequency is low. If it's above 70, then the frequency is high. For the values in the range 45-70, the frequency is moderate. If noise value is less than 20, then noise is high. If it's above 30, then the noise is low. For the values in the range 20-30, the noise level is moderate.

When generating an Assistant response for the dip angle, determine the direction based on the sign of the angle and specify the magnitude of the value as a range defined by multiple of 5 below and above it. Mention that the value is approximate. For example, if dip angle is −62 degrees, then specify that it is dipping right with angle between 60-65 degrees. The conversation should be generated as a Python® list where each element is a dictionary in the format:
“User”: <USER QUESTION WITHOUT MENTION OF NOISE OR FREQUENCY NUMERICAL RANGE>
“Assistant”: <ASSISTANT RESPONSE WITHOUT MENTION OF NOISE OR FREQUENCY NUMERICAL RANGE>

### Example Instruction-Response (Question-Answer) Pairs

User: “What features are visible in the seismic image?
Assistant: The seismic image displays a fold, an unconformity, and multiple faults. The fold indicates ductile deformation, while the unconformity spans across the section, suggesting an angular unconformity dipping east. The faults are distributed across the section with varying dips.
User: Can you describe the fold in the image?
Assistant: The fold in the image represents ductile deformation, indicating structural compression of the subsurface layers
User: How many faults are present in the image?
Assistant: There are four faults visible in the seismic image.”
User: Where is the unconformity located?
Assistant: The unconformity spans across the section, starting at coordinates [0, 44] and ending at coordinates [256, 63]. It dips eastward.
User: Can you describe the dip of the faults?
Assistant: The dips of the faults are as follows: Fault 0 dips right with an approximate angle between 70-75 degrees, Fault 1 dips left with an approximate angle between 60-65 degrees, Fault 2 dips left with an approximate angle between 45-50 degrees, and Fault 3 dips right with an approximate angle between 70-75 degrees.
User: What is the noise level in the image?
Assistant: The noise level in the image is moderate.
User: What is the frequency level in the image?
Assistant: The frequency level in the image is high.

### Exemplary Computing System

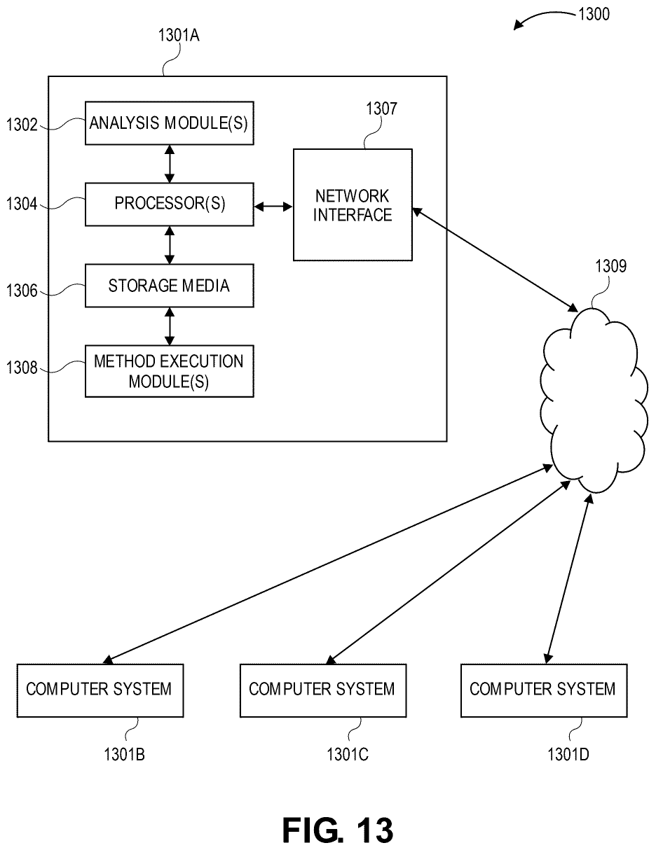

In some embodiments, the methods of the present disclosure may be executed by a computing system. FIG. 13 illustrates an example of such a computing system 1300, in accordance with some embodiments. The computing system 1300 may include a computer or computer system 1301A, which may be an individual computer system 1301A or an arrangement of distributed computer systems. The computer system 1301A includes one or more analysis modules 1302 that are configured to perform various tasks according to some embodiments, such as one or more methods disclosed herein. To perform these various tasks, the analysis module 1302 executes independently, or in coordination with, one or more processors 1304, which is (or are) connected to one or more storage media 1306. The processor(s) 1304 is (or are) also connected to a network interface 1307 to allow the computer system 1301A to communicate over a data network 1309 with one or more additional computer systems and/or computing systems, such as 1301B, 1301C, and/or 1301D (note that computer systems 1301B, 1301C and/or 1301D may or may not share the same architecture as computer system 1301A, and may be located in different physical locations, e.g., computer systems 1301A and 1301B may be located in a processing facility, while in communication with one or more computer systems such as 1301C and/or 1301D that are located in one or more data centers, and/or located in varying countries on different continents).

A processor may include a microprocessor, microcontroller, processor module or subsystem, programmable integrated circuit, programmable gate array, or another control or computing device.

The storage media 1306 may be implemented as one or more computer-readable or machine-readable storage media. Note that while in the example embodiment of FIG. 13 storage media 1306 is depicted as within computer system 1301A, in some embodiments, storage media 1306 may be distributed within and/or across multiple internal and/or external enclosures of computing system 1301A and/or additional computing systems. Storage media 1306 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1300 contains one or more method execution module(s) 1308. In the example of computing system 1300, computer system 1301A includes the method execution module 1308. In some embodiments, a single method execution module may be used to perform some aspects of one or more embodiments of the methods disclosed herein. In other embodiments, a plurality of method execution modules may be used to perform some aspects of methods herein.

It should be appreciated that computing system 1300 is merely one example of a computing system, and that computing system 1300 may have more or fewer components than shown, may combine additional components not depicted in the example embodiment of FIG. 13, and/or computing system 1300 may have a different configuration or arrangement of the components depicted in FIG. 13. The various components shown in FIG. 13 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1300, FIG. 13), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for creating a domain-specific benchmarking dataset for a domain-specific task in an oil and/or gas domain, the method comprising:
receiving input data;
receiving the domain-specific task, wherein the domain-specific task is related to the oil and/or gas domain;
receiving a prompt from a user, wherein the prompt is received by a text or multimodal large language model (LLM); and
generating a plurality of synthetic instruction-response pairs in response to the prompt based upon the input data and the domain-specific task, wherein the synthetic instruction-response pairs are created by the text or multimodal LLM, and wherein the synthetic instruction-response pairs form at least part of the domain-specific benchmarking dataset.

2. The method of claim 1, wherein the input data comprises annotations that serve as a ground truth.

3. The method of claim 2, wherein the annotations are related to features in the input data, types of the features, numbers of the features, locations of the features, relative positions between the features, values of the features, or inferences determined based upon the features and the values.

4. The method of claim 3, wherein the features comprise geological structures or subsurface properties.

5. The method of claim 4, wherein the features comprise the geological structures including faults, unconformities, dips, or folds.

6. The method of claim 4, wherein the features comprise the subsurface properties including lithology, porosity, fluid type, or reservoir zones.

7. The method of claim 3, wherein the annotations are related to the values, and wherein the values comprise seismic attributes or well log measurements.

8. The method of claim 7, wherein the values comprise the seismic attributes including amplitude, noise, frequency, dip, azimuth, or coherence.

9. The method of claim 7, wherein the values comprise the well log measurements including gamma ray, resistivity, density, neutron porosity, sonic travel time, or water saturation.

10. The method of claim 3, wherein the annotations are related to the inferences, and wherein the inferences comprise structural interpretation, stratigraphic interpretation, lithology identification, or reservoir characterization.

11. A computing system, comprising:
one or more processors; and
a memory system comprising one or more non-transitory computer-readable media storing instructions that, when executed by at least one of the one or more processors, cause the computing system to perform operations, the operations comprising:
receiving input data including annotations that serve as a ground truth;
receiving a domain-specific task, wherein the domain-specific task is related to an oil and/or gas domain;
receiving a prompt from a subject matter expert (SME), wherein the prompt is received by a text or multimodal large language model (LLM); and
generating a plurality of synthetic instruction-response pairs in response to the prompt based upon the input data and the domain-specific task, wherein the synthetic instruction-response pairs are created by the text or multimodal LLM, and wherein the synthetic instruction-response pairs form at least part of a domain-specific benchmarking dataset.

12. The computing system of claim 11, wherein the domain-specific task comprises question answering, report generation, summarization, image captioning and analysis, or measurement log analysis.

13. The computing system of claim 11, wherein the oil and/or gas domain comprises petroleum engineering, seismic interpretation, well log interpretation, drilling, production, or reservoir simulation.

14. The computing system of claim 11, wherein the domain-specific task comprises a plurality of examples.

15. The computing system of claim 11, wherein the synthetic instruction-response pairs comprise question-answer pairs, image-caption pairs, image-annotation pairs, input-summary pairs, multi-turn conversation-response pairs, or input-analysis pairs.

16. A non-transitory computer-readable medium storing instructions that, when executed by one or more processors of a computing system, cause the computing system to perform operations, the operations comprising:
receiving input data, wherein the input data comprises annotations, wherein the annotations are related to features in the input data, types of the features, numbers of the features, locations of the features, relative positions between the features, values of the features, and inferences determined based upon the features and the values, wherein the features comprise geological structures and subsurface properties, wherein the geological structures comprise faults, unconformities, dips, and folds, wherein the subsurface properties comprise lithology, porosity, fluid type, and reservoir zones, wherein the values comprise seismic attributes and well log measurements, wherein the seismic attributes comprise amplitude, noise, frequency, dip, azimuth, and coherence, wherein the well log measurements comprise gamma ray, resistivity, density, neutron porosity, sonic travel time, and water saturation, wherein the inferences comprise structural interpretation, stratigraphic interpretation, lithology identification, and reservoir characterization, wherein the input data with the annotations serves as a ground truth, wherein the annotations are received from a user that is a subject matter expert (SME), wherein the input data is sourced from real-world or simulated environments, wherein the input data is sourced from structured and unstructured data including oil and/or gas textbooks, portable document format (PDF) documents, webpages, geophysical surveys, well logs, scientific publications, geological reports, or maps, wherein the input data is in text format, tabular format, graphical format, mathematical format, or image format, and wherein the input data in the image format comprises a seismic image;
receiving a domain-specific task, wherein the domain-specific task comprises question answering, report generation, summarization, image captioning and analysis, or measurement log analysis, wherein the domain-specific task is related to an oil and/or gas domain, wherein the oil and/or gas domain comprises petroleum engineering, seismic interpretation, well log interpretation, drilling, production, or reservoir simulation, and wherein the domain-specific task comprises a plurality of examples;
receiving a prompt from the SME, wherein the prompt is received by a text or multimodal large language model (LLM); and
generating a plurality of synthetic instruction-response pairs in response to the prompt based upon the input data and the domain-specific task, wherein the synthetic instruction-response pairs comprise question-answer pairs, image-caption pairs, image-annotation pairs, input-summary pairs, multi-turn conversation-response pairs, or input-analysis pairs, wherein the synthetic instruction-response pairs are created by the text or multimodal LLM, and wherein the synthetic instruction-response pairs form at least part of a domain-specific benchmarking dataset.

17. The non-transitory computer-readable medium of claim 16, wherein the operations further comprise iteratively assessing and improving an accuracy and a quality of the domain-specific benchmarking dataset based upon feedback from domain-specific models or the SME.

18. The non-transitory computer-readable medium of claim 16, wherein the operations further comprise assessing a performance of different text or multimodal LLMs and/or retrieval augmented generation (RAG) pipelines performing the domain-specific task by comparing responses from the different text or multimodal LLMs and/or RAG pipelines to the domain-specific benchmarking dataset.

19. The non-transitory computer-readable medium of claim 16, wherein the operations further comprise displaying the domain-specific benchmarking dataset.

20. The non-transitory computer-readable medium of claim 16, wherein the operations further comprise:
receiving an instruction;
generating a response to the instruction using the text or multimodal LLM based upon the domain-specific benchmarking dataset; and
performing an action in response to the response, wherein the action comprises generating and transmitting a signal that recommends, instructs, or causes a physical action to occur at a wellsite, and wherein the physical action comprises drilling a wellbore, varying a weight and/or torque on a drill bit that is drilling the wellbore, varying a drilling trajectory of the wellbore, or varying a concentration and/or flow rate of a fluid pumped into the wellbore.
